(19) United States
(12) Patent Application Publication
(10) Pub. No.: US 2016/0337947 A1
(43) Pub. Date: Nov. 17, 2016

(54) OPTIMIZED PUBLIC LAND MOBILE NETWORK SEARCH TO REDUCE DATA THROUGHPUT DEGRADATION

(71) Applicant: QUALCOMM Incorporated, San Diego, CA (US)

(72) Inventors: Damon Beales, Reading (GB); Neha Goel, Woking (GB); Divaydeep Sikri, Woking (GB); Mungal Dhanda, Slough (GB)

(21) Appl. No.: 14/712,563

(22) Filed: May 14, 2015

(51) Int. Cl. H04W 48/16; H04W 48/18

(52) U.S. Cl. CPC H04W 48/16; H04W 48/18

(57) ABSTRACT

A method for performing a manual public land mobile network (PLMN) selection that includes: selecting an absolute radio frequency channel number (ARFCN) from an ARFCN set for one or more frequency bands supported by or enabled on a mobile communication device; determining whether the selected ARFCN is included in at least one allocation table of a first cell of a first PLMN; in response to determining that the selected ARFCN is not included in the at least one allocation table of the first cell of the first PLMN, adding the selected ARFCN to a second ARFCN set; and determining a PLMN identity (PLMN-ID) for each ARFCN in the second ARFCN set.

### BACKGROUND

A user may cause a mobile communication device to perform a manual public land mobile network (PLMN) selection in order to identify one or more available PLMNs. For example, while the mobile communication device is camped on a cell associated with one PLMN, the mobile communication device may perform a manual PLMN selection to locate other PLMNs operating in one or more frequency bands supported by or enabled on the mobile communication device.

During a manual PLMN selection, a mobile communication device may perform a power scan by measuring one or more received signal strength indicators (RSSIs) across every absolute radio frequency channel number (ARFCN) in the one or more frequency bands that are supported by or enabled on the mobile communication device. However, during conventional PLMN selection, the mobile communication device may decode a frequency correction channel (FCCH), synchronization channel (SCH), and broadcast control channel (BCCH) for every ARFCN having a measured signal strength that exceeds certain thresholds.

Specifically, the mobile communication device may be required to decode an FCCH, SCH, and BCCH for an ARFCN in order to acquire information to determine a PLMN identity (PLMN-ID) of a PLMN associated with a corresponding cell. As such, although the mobile communication device may have already determined a PLMN-ID of a PLMN associated with the camped-on cell, the mobile communication device may still decode other ARFCNs that are also allocated to the camped-on cell but are used for traffic and frequency hopping.

Consequently, conventional PLMN selection may be time consuming. In a multi-subscriber identity module (SIM) multi-standby (MSMS) mobile communication device, one subscription may utilize a single shared radio frequency (RF) chain to perform a lengthy manual PLMN selection that degrades data throughput on one or more other subscriptions.

### SUMMARY

Apparatuses and methods for optimizing PLMN selection to reduce data throughput degradation are provided.

According to the various embodiments, there is provided a method for performing a PLMN selection. The method may include: selecting an ARFCN from an ARFCN set for one or more frequency bands supported by or enabled on a mobile communication device; determining whether the selected ARFCN is included in at least one allocation table of a first cell of a first PLMN; in response to determining that the selected ARFCN is not included in the at least one allocation table of the first cell of the first PLMN, adding the selected ARFCN to a second ARFCN set; and determining a PLMN identity (PLMN-ID) for each ARFCN in the second ARFCN set.

According to the various embodiments, there is provided a mobile communication device. In some embodiments, the mobile communication device may include a control unit and an RF chain.

The control unit may be configured to: select an ARFCN from a first ARFCN set for one or more frequency bands supported by or enabled on a mobile communication device; determine whether the selected ARFCN is included in at least one allocation table of a first cell of a first PLMN; in response to determining that the selected ARFCN is not included in the at least one allocation table of the first cell of the first PLMN, add the selected ARFCN to a second ARFCN set; and determine a PLMN identity (PLMN-ID) for each ARFCN in the second ARFCN set.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a system diagram illustrating a network environment according to various embodiments;

FIG. 2 is a block diagram illustrating a mobile communication device according to various embodiments;

FIG. 3 is a flowchart illustrating a process for performing a manual PLMN selection according to various embodiments;

FIG. 4 is a flowchart illustrating a process for generating an ARFCN set according to various embodiments;

FIG. 5 is a flowchart illustrating a process for performing a power scan according to various embodiments; and

FIG. 6 is a flowchart illustrating a process for performing a manual PLMN selection according to various embodiments.

### DETAILED DESCRIPTION

While a number of embodiments are described herein, these embodiments are presented by way of example only, and are not intended to limit the scope of protection. The apparatuses and methods described herein may be embodied in a variety of other forms. Furthermore, various omissions, substitutions, and changes in the form of the example apparatuses and methods described herein may be made without departing from the scope of protection.

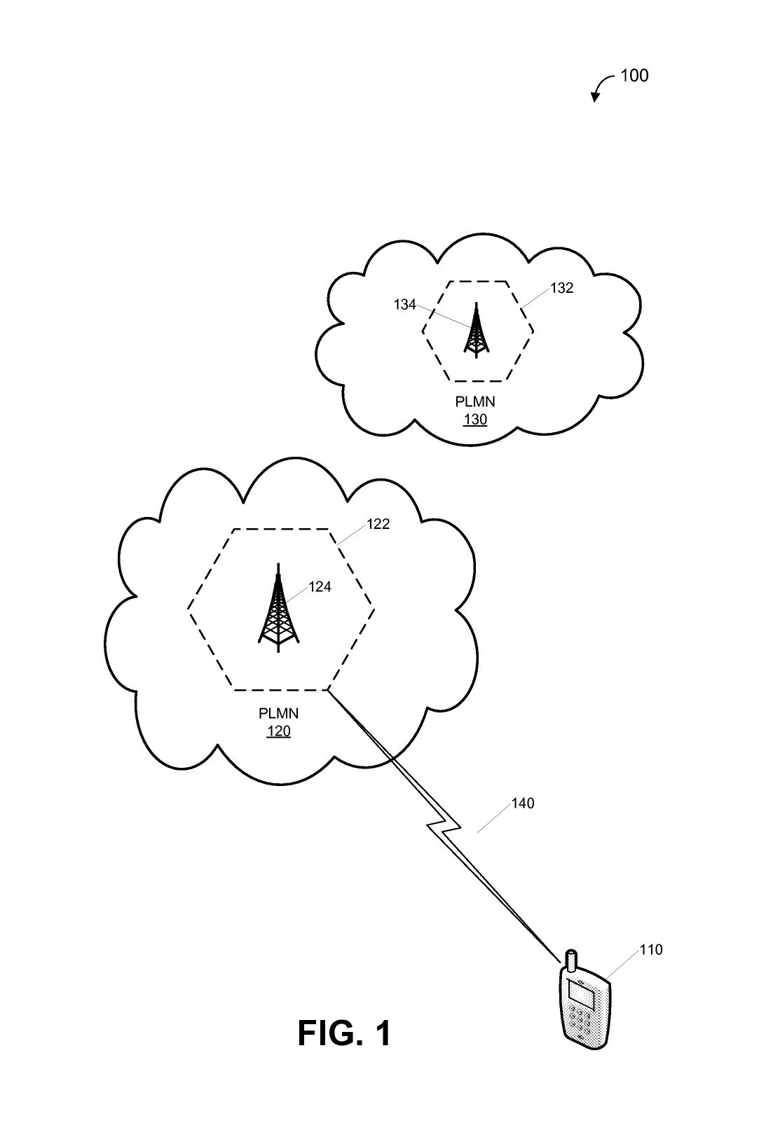

FIG. 1 is a system diagram illustrating a network environment 100 according to various embodiments. Referring to FIG. 1, in various embodiments, a first PLMN 120 may include a first cell 122 associated with a first base transceiver station (BTS) 124. In various embodiments, the first PLMN 120 may be, for example, but not limited to, a wireless or mobile communication network.

Although the first PLMN 120 is shown to include one cell (e.g., the first cell 122), a person having ordinary skill in the art can appreciate that the first PLMN 120 may include additional cells and corresponding BTSs without departing from the scope of the present inventive concept.

In various embodiments, a second PLMN 130 may include a second cell 132 associated with a second BTS 134. In various embodiments, the second PLMN 130 may be, for example, but not limited to, a wireless or mobile communication network. Although the second PLMN 130 is shown to include one cell (e.g., the second cell 132), a person having ordinary skill in the art can appreciate that the second PLMN 130 may include additional cells and corresponding BTSs without departing form the scope of the present inventive concept.

One cell belonging to a PLMN may be allocated one or more ARFCNs. For example, the first BTS 124 of the first cell 122 will broadcast a PLMN-ID of the first PLMN 120 on one or more ARFCNs allocated to the first cell 122. The second BTS 134 of the second cell 132 may broadcast a PLMN-ID of the second PLMN 130 on one or more ARFCNs allocated to the second cell 132.

A mobile communication device 110 may communicate with the first PLMN 120 on a first subscription 140. For example, the mobile communication device 110 may communicate with the first PLMN 120 on the first subscription 140 via the first cell 122 (or a different cell). When the mobile communication device 110 camps on the first cell 122 of the first PLMN 120, the mobile communication device 110 may decode information broadcast on a BCCH by the first BTS 124 of the first cell 122 and determine a PLMN-ID of the first PLMN 120.

While the mobile communication device 110 is camped on the first cell 122 of the first PLMN 120, a user may cause the mobile communication device 110 to perform a manual PLMN selection on the first subscription 140 in order to identify one or more available PLMNs including, for example, but not limited to, the first PLMN 120 and the second PLMN 130. During the manual PLMN selection, the mobile communication device 110 may decode information broadcast on a BCCH by the second BTS 134 of the second cell 132 in order to determine a PLMN-ID of the second PLMN 130. The mobile communication device 110 may report available PLMNs to a user based on the PLMN-ID of the first PLMN 120 and the PLMN-ID of the second PLMN 130.

A person having ordinary skill in the art can appreciate that the mobile communication device 110 may communicate with a different PLMN on a different subscription without departing from a scope of the present inventive concept. Moreover, the mobile communication device 110 may perform a manual PLMN selection on a different subscription without departing from a scope of the present inventive concept.

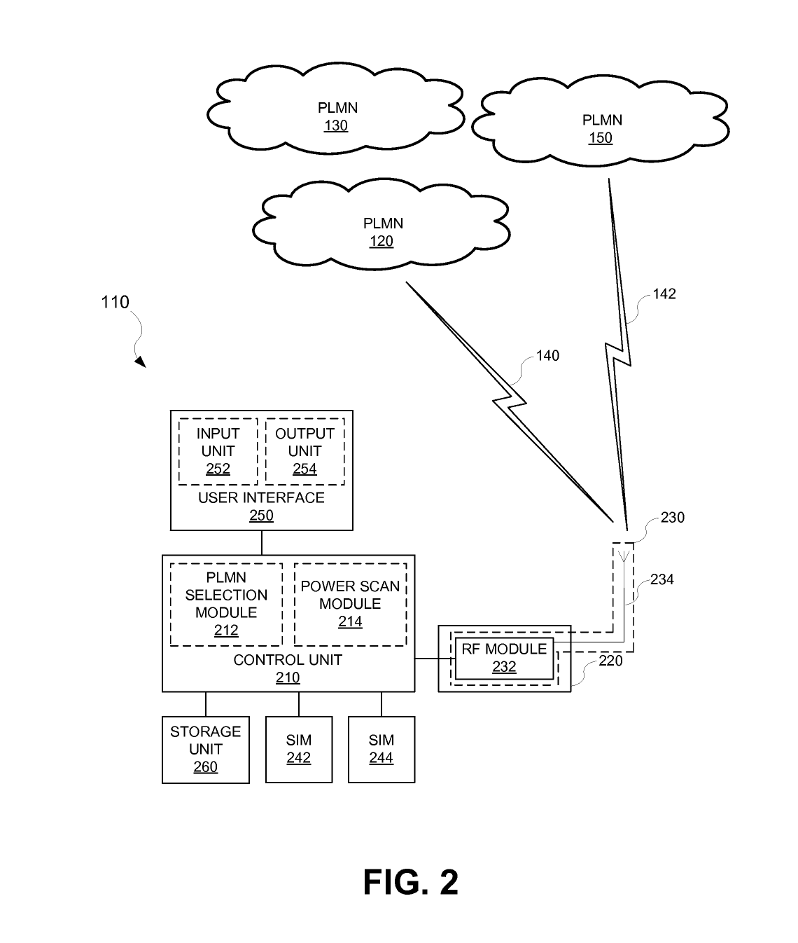

FIG. 2 is a block diagram illustrating a mobile communication device 110 according to various embodiments. Referring to FIGS. 1 and 2, in various embodiments, the mobile communication device 110 may include a control unit 210, a communication unit 220, a first SIM 242, a second SIM 244, a user interface 250, and storage unit 260.

In various embodiments, the mobile communication device 110 may be any device capable of wirelessly communicating with one or more PLMNs including, for example, but not limited to, the first PLMN 120, the second PLMN 130, and a third PLMN 150. In various embodiments, the mobile communication device 110 may be, for example, but not limited to, a smartphone, a tablet PC, or a laptop computer.

In various embodiments, the communication unit 220 may include an RF chain 230. The RF chain 230 may include, for example, but not limited to, an RF module 232 and an antenna 234.

Although the mobile communication device 110 is shown to include a single communication unit (e.g., the communication unit 220), a person of ordinary skill in the art can appreciate that the mobile communication device 110 may include additional communication units without departing from the scope of the present inventive concept.

In various embodiments, the first SIM 242 may associate the communication unit 220 with a first subscription 140 on the first PLMN 120, and the second SIM 244 may associate the communication unit 220 with a second subscription 142 on the third PLMN 150. For clarity and convenience, throughout this disclosure, the first SIM 242 associates the communication unit 220 with the first subscription 140 and the second SIM 244 associates the communication unit 220 with the second subscription 142. However, a person having ordinary skill in the art can appreciate that either SIM may associate the communication unit 220 with either subscription without departing from the scope of the present inventive concept.

In various embodiments, the first PLMN 120, the second PLMN 130, and the third PLMN 150 may each be operated by the same mobile network operator (MNO) or by different MNOs. Additionally, in various embodiments, the first PLMN 120, the second PLMN 130, and the third PLMN 150 may each implement the same radio access technology (RAT) or different RATs, including, for example, but not limited to Wideband Code Division Multiple Access (WCDMA), Global System for Mobile communications (GSM), Long Term Evolution (LTE), and Time Division-Synchronous Code Division Multiple Access (TD-SCDMA).

In various embodiments, the control unit 210 may be configured to control an overall operation of the mobile communication device 110 including controlling the functions of the communication unit 220. In various embodiments, the control unit 210 may include a PLMN selection module 212 configured to perform one or more manual PLMN selections on the first subscription 140 and/or the second subscription 142. In various embodiments, the control unit 210 may further include a power scan module 214 configured to perform a power scan across one or more frequency bands supported by or enabled on the mobile communication device 110.

In various embodiments, the control unit 210 may be, for example, but not limited to, a microprocessor (e.g., general-purpose processor, baseband modem processor, etc.) or a microcontroller. While the control unit 210 is shown to include the PLMN selection module 212 and the power scan module 214, a person having ordinary skill in the art can appreciate that at least some operations performed by the PLMN selection module 212 and the power scan module 214 may be implemented by the control unit 210 or by one or more different components of the mobile communication device 110 without departing from a scope of the present inventive concept.

In various embodiments, the user interface 250 may include an input unit 252. In some embodiments, the input unit 252 may be, for example, but not limited to, a keyboard or a touch panel. A person having ordinary skill in the art can appreciate that other types or forms of input units may be used without departing from the scope of the present inventive concept.

In various embodiments, the user interface 250 may include an output unit 254. In various embodiments, the output unit 254 may be configured to display a result of a manual PLMN selection performed by the control unit 210 (e.g., the PLMN selection module 212) including, for example, but not limited to, an indication of one or more available PLMNs. In some embodiments, the output unit 254 may be, for example, but not limited to, a liquid crystal display (LCD) or a light emitting diode (LED) display. A person of ordinary skill in the art will appreciate that other types or forms of output units may be used without departing from the scope of the present inventive concept.

In various embodiments, the storage unit 260 may be configured to store application programs, application data, and user data. In various embodiments, at least some of the application programs stored at the storage unit 260 may be executed by the control unit 210 for the operation of the mobile communication device 110.

In various embodiments, while the mobile communication device 110 is camped on the first cell 122 on the first subscription 140 (or the second subscription 142), the control unit 210 may be configured to utilize the RF chain 230 to perform one or more manual PLMN selections on the first subscription 140 (or the second subscription 142). For example, the control unit 210 may tune away from an activity (e.g., a data call) on the second subscription 142 in order to utilize the RF chain 230 to perform a manual PLMN selection on the first subscription 140.

During a manual PLMN selection, the control unit 210 may be configured to generate an ARFCN set that excludes one or more ARFCNs allocated to the first cell 122 and included in at least one allocation table of the first cell 122. For example, the ARFCN set may exclude ARFCNs included in a cell allocation (CA) table and/or mobile allocation (MA) table of the first cell 122.

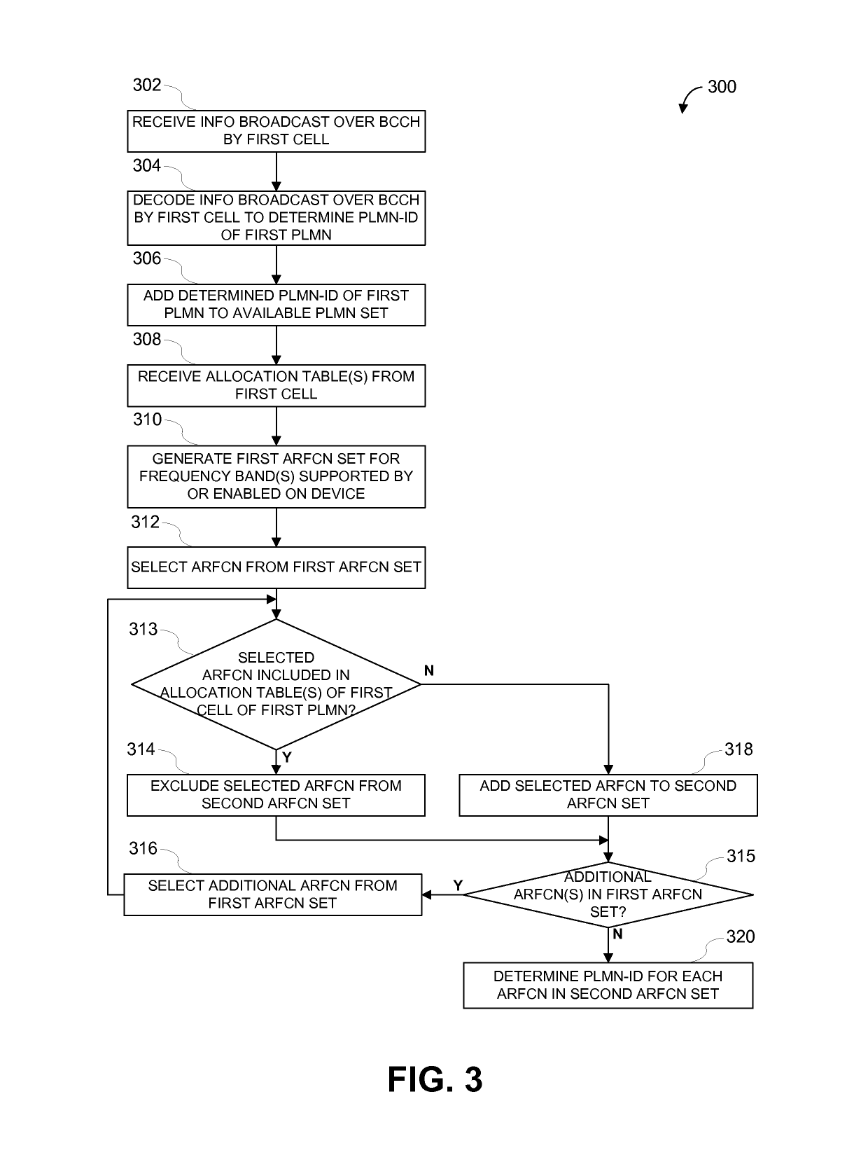

FIG. 3 is a flowchart illustrating a process 300 for performing a manual PLMN selection according to various embodiments. Referring to FIGS. 1-3, the process 300 may be performed by the control unit 210, for example, by the PLMN selection module 212.

The mobile communication device 110 camped on the first cell 122 may receive information broadcast over a BCCH by a first cell (e.g., the first cell 122) (302). The control unit 210 may decode information broadcast by the first cell 122 over an SCH and an FCCH. The control unit 210 may decode information (e.g., one or more system information (SI) messages) broadcast by the first cell 122 over a BCCH based on at least a portion of the information received from the first cell 122 over the SCH and the FCCH. The first BTS 124 of the first cell 122 may broadcast over the BCCH in one or more SI messages the PLMN-ID of the first PLMN 120. Accordingly, the control unit 210 may decode information broadcast over the BCCH by the first cell 122 to determine the PLMN-ID of the first PLMN 120 (304).

The control unit 210 may add the determined PLMN-ID of the first PLMN 120 to an available PLMN set (306). For example, the control unit 210 may add the PLMN-ID of the first PLMN 120 to an available PLMN set by storing the PLMN-ID of the first PLMN 120 in the storage unit 260.

The control unit 210 may receive at least one allocation table from the first cell 122 (308). The first BTS 124 of the first cell 122 may broadcast over the BCCH one or more SI messages that include a cell allocation (CA) table and/or a mobile allocation (MA) table for the first cell 122. The CA table and/or the MA table may include one or more ARFCNs that may all be allocated to the first cell 122 for traffic and/or frequency hopping.

The control unit 210 may generate a first ARFCN set for one or more frequency bands supported by or enabled on the mobile communication device 110 (310). For example, the control unit 210 may perform a power scan across ARFCNs in one or more frequency bands supported by or enabled on the mobile communication device 110. The control unit 210 may generate the first ARFCN set based on a result of the power scan.

The control unit 210 may select an ARFCN from the first ARFCN set (312). Then, the control unit 210 may determine whether the selected ARFCN is included in the at least one allocation table of the first cell 122 of the first PLMN 120 (313). For example, the selected ARFCN may be allocated to the first cell 122 belonging to the first PLMN 120.

If the control unit 210 determines that the selected ARFCN is included in the at least one allocation table of the first cell 122 of the first PLMN 120 (313-Y), the control unit 210 may exclude the selected ARFCN from a second ARFCN set (314) and may determine whether there are one or more additional ARFCNs in the first ARFCN set (315).

For example, during the manual PLMN selection, the control unit 210 may not add an ARFCN from the first ARFCN set to the second ARFCN set if the ARFCN is allocated to the first cell 122. The control unit 210 may continue examining the remaining ARFCNs included in the first ARFCN set. If the control unit 210 determines there is not one or more additional ARFCNs in the first ARFCN set (315-N), the control unit 210 may determine a PLMN-ID for each ARFCN included in the second ARFCN set (320). The control unit 210 may determine a PLMN-ID for one or more ARFCNs included in the second ARFCN set but the control unit 210 may not determine a PLMN-ID for one or more ARFCNs excluded from the second ARFCN set. As such, the control unit 210 may not determine a PLMN-ID for the first cell 122 associated with the first PLMN 120 since the control unit 210 may have already decoded the PLMN-ID of the first PLMN 120 from the first cell 122 at the operation 304. If the control unit 210 determines there are one or more additional ARFCNs in the first ARFCN set (315-Y), the control unit 210 may select one of the one or more additional ARFCNs from the first ARFCN set (316), and the process may continue at the operation 313.

Alternately, the control unit 210 may determine that the selected ARFCN is not included in the at least one allocation table of the first cell 122 of the first PLMN 120 (313-N). For example, the mobile communication device 110 may be camped on the first cell 122 of the first PLMN 120. The selected ARFCN may be allocated to the second cell 132 associated with the second PLMN 130. As such, the control unit 210 may add the selected ARFCN to the second ARFCN set (318).

The control unit 210 may determine whether there are one or more additional ARFCNs in the first ARFCN set (315). If the control unit 210 determines there are one or more additional ARFCNs in the first ARFCN set (315-Y), the control unit 210 may select one of the one or more additional ARFCNs from the first ARFCN set (316), and the process may continue at the operation 313. Alternately, if the control unit 210 determines there is not one or more additional ARFCNs in the first ARFCN set (315-N), the control unit 210 may determine a PLMN-ID for each ARFCN in the second ARFCN set (320).

A person having ordinary skill in the art can appreciate that the control unit 210 may perform the process 300 on the first subscription 140 and/or the second subscription 142 without departing from a scope of the present inventive concept. Moreover, at least some of the operations in the process 300 may be performed in a different order without departing from a scope of the present inventive concept.

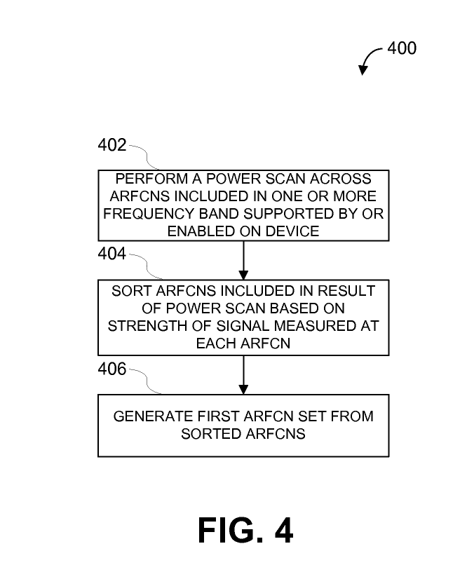

FIG. 4 is a flowchart illustrating a process 400 of generating an ARFCN set according to various embodiments. Referring to FIGS. 1-4, in various embodiments, the process 400 may be performed by the control unit 210, for example, by the PLMN selection module 212. The process 400 may implement the operation 310 of the process 300.

The control unit 210 may perform a power scan across a plurality of ARFCNs included in one or more frequency bands supported by or enabled on the mobile communication device 110 (402). For example, the control unit 210 may perform a power scan across every ARFCN in one or more frequency bands supported by or enabled on the mobile communication device 110. The mobile communication device 110 may support or enable a plurality of ARFCNs, for example, but not limited to, 971 ARFCNs

The control unit 210 may sort a plurality of ARFCNs included in a result of the power scan based at least in part on a strength of a signal or other suitable metric measured at each ARFCN (404). For example, a result of the power scan may include a portion of the ARFCNs (e.g., 220 or another number ARFCNs) included in the one or more frequency bands supported by or enabled on the mobile communication device 110. The control unit 210 may sort the ARFCNs included in the result of the power scan based on one or more RSSIs.

The control unit 210 may generate the first ARFCN set from the sorted plurality of ARFCNs (406). The first ARFCN set may include at least a portion of the sorted ARFCNs. For example, the control unit 210 may generate the first ARFCN set by selecting a subset of ARFCNs from the sorted ARFCNs (e.g., 140 or another number of the 220 ARFCNs) having a highest measured signal strength. For instance, the subset may be selected to include a predetermined number of ARFCNs with the highest measured signal strengths (e.g., selecting the top n ARFCNs in terms of highest measured signal strength). Alternately or additionally, the control unit 210 may generate the first ARFCN set by selecting a subset of ARFCNs from the sorted ARFCNs having a measured signal strength that exceeds one or more thresholds.

A person having ordinary skill in the art can appreciate that the control unit 210 may perform the process 400 on the first subscription 140 and/or the second subscription 142 without departing from a scope of the present inventive concept.

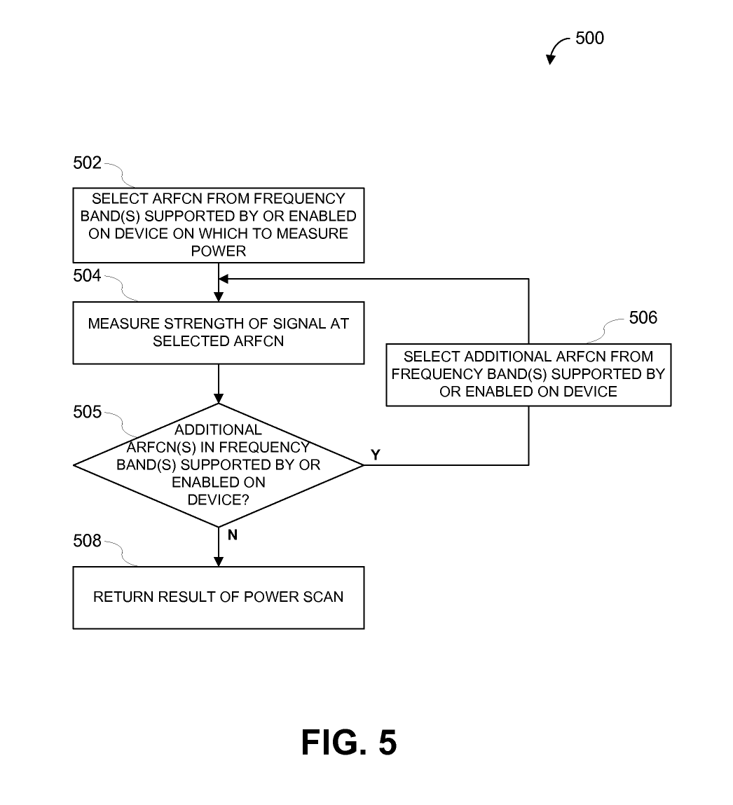

FIG. 5 is a flowchart illustrating a process 500 for performing a power scan according to various embodiments. Referring to FIGS. 1-5, in various embodiments, the process 500 may be performed by the control unit 210, for example, by the power scan module 214. The process 500 may implement the operation 402 of the process 400.

The control unit 210 may select an ARFCN from one or more frequency bands supported by or enabled on the mobile communication device 110 on which to measure power (502). The control unit 210 may measure a strength of a signal at the selected ARFCN (504). For example, during a power scan, the control unit 210 may measure one or more RSSIs for a signal at a selected ARFCN including, for example, but not limited to, an RxLev and an RxQual.

The control unit 210 may determine whether there are one or more additional ARFCNs in the one or more frequency bands supported by or enabled on the mobile communication device 110 (505). If the control unit 210 determines that there are one or more additional ARFCNs in the one or more frequency bands supported by or enabled on the mobile communication device 110 (505-Y), the control unit 210 may select one of the one or more additional ARFCNs from the one or more frequency bands supported by or enabled on the mobile communication device 110 (506) and the process 500 may continue at the operation 504.

Alternately, the control unit 210 may determine that there is not one or more additional ARFCNs in the one or more frequency bands supported by or enabled on the mobile communication device 110 (505-N). For example, the control unit 210 may determine that the signal strengths of all of the ARFCNs in the one or more frequency bands supported by or enabled on the mobile communication device 110 have been measured.

The control unit 210 may return a result of a power scan (508). For example, during the power scan, the control unit 210 may detect and measure a signal for at least a subset of the ARFCNs (e.g., 220 of 971 ARFCNs) included in the one or more frequency bands supported by or enabled on the mobile communication device 110. The result of the power scan may include the subset of detected ARFCNs for which power was measured.

A person having ordinary skill in the art can appreciate that the control unit 210 may perform the process 500 on the first subscription 140 and/or the second subscription 142 without departing from a scope of the present inventive concept.

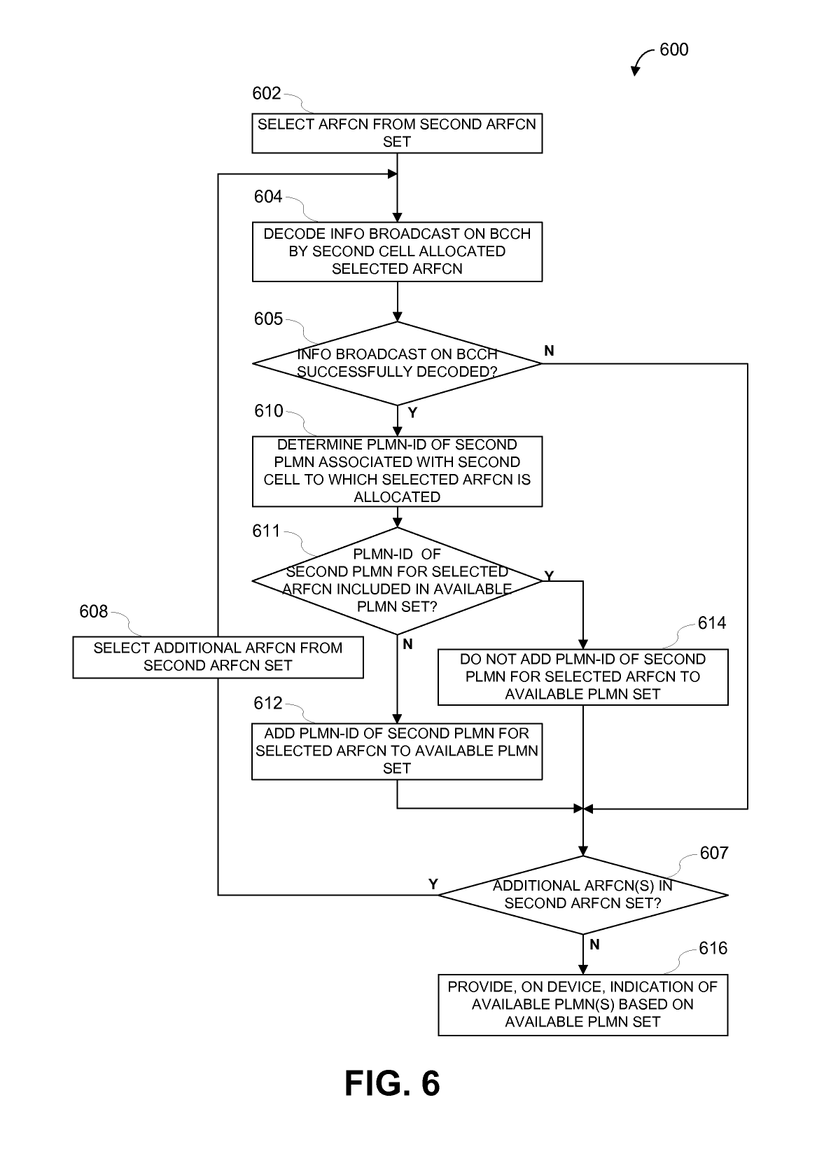

FIG. 6 is a flowchart illustrating a process 600 for performing a manual PLMN selection according to various embodiments. Referring to FIGS. 1-3 and 6, in various embodiments, the process 500 may be performed by the control unit 210, for example, by the PLMN selection module 212. The process 600 may implement the operation 320 of the process 300.

The control unit 210 may select an ARFCN from the second ARFCN set (602). The control unit 210 may decode information broadcast on a BCCH by a second cell (e.g., the second cell 132) to which the selected ARFCN is allocated (604). For example, the second ARFCN set may include an ARFCN allocated to the second cell 132 belonging to the second PLMN 130. The control unit 210 may decode information broadcast on an SCH and an FCCH by the second BTS 134 of the second cell 132 associated with the second PLMN 130. The control unit 210 may decode information (e.g., one or more SI messages) broadcast on the BCCH by the second cell 132 based on at least a portion of the information received on the SCH and the FCCH.

The control unit 210 may determine whether information broadcast on the BCCH is successfully decoded (605). If the control unit 210 determines that information broadcast on the BCCH is not successfully decoded (605-N), the control unit 210 may determine whether there are one or more additional ARFCNs in the second ARFCN set (607). For example, if the control unit 210 is unable to decode information (e.g., one or more SI messages) broadcast on the BCCH by the second BTS 134 of second cell 132 associated with the second PLMN 130, the control unit 210 may continue examining the remaining ARFCNs included the second ARFCN set. If the control unit 210 determines there are one or more additional ARFCNs in the second ARFCN set (607-Y), the control unit 210 may select one of the one or more additional ARFCNs from the second ARFCN set (608) and the process may continue at the operation 604.

Alternately, if the control unit 210 determines that the information broadcast on the BCCH is successfully decoded (605-Y), the control unit 210 may determine a PLMN-ID of the second PLMN 130 associated with the second cell 132 to which the selected ARFCN is allocated (610). For example, the second cell 132 to which the selected ARFCN is allocated may belong to the second PLMN 130. The control unit 210 may determine a PLMN-ID of the second PLMN 130 based on information (e.g., one or more SI messages) broadcast on the BCCH from the second cell 132 for the selected ARFCN.

The control unit 210 may determine whether the PLMN-ID of the second PLMN 130 for the selected ARFCN is included in the available PLMN set (611). If the control unit 210 determines that the PLMN-ID of the second PLMN 130 is already included in the available PLMN set (611-Y), the control unit 210 may not add the PLMN-ID of the second PLMN 130 for the selected ARFCN to the available PLMN set (614). For example, the available PLMN set may include one or more unique PLMN-IDs. As such, the control unit 210 may not add the PLMN-ID of the second PLMN 130 to the available PLMN set if the PLMN-ID of the second PLMN 130 is already included in the available PLMN set.

Alternately, if the control unit 210 determines that the PLMN-ID of the second PLMN 130 is not included in the available PLMN set (611-N), the control unit 210 may add the PLMN-ID of the second PLMN 130 to the available PLMN set (612).

Then after the operations 612 or 614, the control unit 210 may determine whether there are one or more additional ARFCNs in the second ARFCN set (607). If the control unit 210 determines there are one or more additional ARFCNs in the second ARFCN set (607-Y), the control unit 210 may select one of the one or more additional ARFCNs from the second ARFCN set (608), and the process 600 may continue at the operation 604.

Alternately, if the control unit determines that there is not one or more additional ARFCNs in the second ARFCN set (607-N), the control unit 210 may provide, on the mobile communication device 110, an indication of one or more available PLMNs based on the available PLMN set (616). For example, the control unit 210 may display, on the mobile communication device 110, one or more available PLMNs corresponding to the PLMN-IDs included in the available PLMN set to a user (e.g., via the output unit 254). For example, the mobile communication device 110 may be camped on the first cell 122 of the first PLMN 120. As such, the available PLMN set may include the PLMN-IDs of the first PLMN 120 and the second PLMN 130. The control unit 210 may receive a selection of a PLMN of the one or more available PLMNs. The control unit 210 may perform a PLMN selection based on the selected PLMN to register the mobile communication device 110 on the selected PLMN.

A person having ordinary skill in the art can appreciate that the control unit 210 may perform the process 600 on the first subscription 140 and/or the second subscription 142 without departing from a scope of the present inventive concept.

The accompanying claims and their equivalents are intended to cover such forms or modifications as would fall within the scope and spirit of the protection. For instance, the example apparatuses, methods, and systems disclosed herein may be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, modules, and circuits described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for performing public land mobile network (PLMN) selection, comprising:
selecting an absolute radio frequency channel number (ARFCN) from a first ARFCN set, the first ARFCN set comprising one or more frequency bands supported by or enabled on a mobile communication device;
determining whether the selected ARFCN is included in at least one allocation table of a first cell of a first PLMN;
in response to determining that the selected ARFCN is not included in the at least one allocation table of the first cell of the first PLMN, adding the selected ARFCN to a second ARFCN set; and
determining a PLMN identity (PLMN-ID) for each ARFCN in the second ARFCN set.

2. The method of claim 1, further comprising:
in response to determining that the selected ARFCN is included in the at least one allocation table of the first cell of the first PLMN, excluding the selected ARFCN from the second ARFCN set.

3. The method of claim 2, wherein a PLMN-ID is not determined for one or more ARFCNs that are not included in the second ARFCN set.

4. The method of claim 1, wherein determining the PLMN-ID for each ARFCN in the second ARFCN set comprises:
selecting an ARFCN from the second ARFCN set;
decoding information broadcast on a broadcast control channel (BCCH) by a second cell to which the selected ARFCN is allocated; and
determining a PLMN-ID of a second PLMN associated with the second cell to which the selected ARFCN is allocated.

5. The method of claim 4, further comprising:
determining whether the PLMN-ID of the second PLMN is included in an available PLMN set; and
in response to determining the PLMN-ID of the second PLMN is not included in the available PLMN set, adding the PLMN-ID of the second PLMN to the available PLMN set.

6. The method of claim 5, further comprising:
in response to determining the PLMN-ID of the second PLMN is included in the available PLMN set, excluding the PLMN-ID of the second PLMN from the available PLMN set.

7. The method of claim 5, further comprising adding a PLMN-ID of the first PLMN to the available PLMN set.

8. The method of claim 7, further comprising providing, on the mobile communication device, an indication of one or more available PLMNs based at least in part on the available PLMN set.

9. The method of claim 8, wherein providing, on the mobile communication device, the indication of the one or more available PLMNs comprises displaying, on the mobile communication device, one or more available PLMNs corresponding to the PLMN-IDs included in the available PLMN set to a user.

10. The method of claim 8, further comprising:
receiving a selection of a PLMN of the one or more available PLMNs; and
performing a PLMN selection based on the selected PLMN to register the mobile communication device on the selected PLMN.

11. The method of claim 1, further comprising providing, on the mobile communication device, an indication of one or more available PLMNs based at least in part on the PLMN-ID for each of the ARFCNs in the second ARFCN set.

12. The method of claim 1, further comprising generating the first ARFCN set for the one or more frequency bands supported by or enabled on the mobile communication device.

13. The method of claim 12, wherein generating the first ARFCN set comprises:
performing a power scan across a plurality of ARFCNs included in the one or more frequency bands supported by or enabled on the mobile communication device;
sorting a plurality of ARFCNs included in a result of the power scan based at least in part on a strength of a signal measured at each ARFCN; and
generating the first ARFCN set from the sorted plurality of ARFCNs.

14. The method of claim 13, wherein generating the first ARFCN set from the sorted plurality of ARFCNs comprises selecting a subset of ARFCNs from the sorted plurality of ARFCNs having a highest measured signal strength.

15. The method of claim 13, wherein generating the first ARFCN set from the sorted plurality of ARFCNs comprises selecting one or more ARFCNs from the sorted plurality of ARFCNs having a measured signal strength that exceeds one or more thresholds.

16. The method of claim 13, wherein performing the power scan comprises:
selecting an ARFCN from the one or more frequency bands supported by or enabled on the mobile communication device; and
measuring a strength of a signal at the selected ARFCN.

17. The method of claim 1, wherein the at least one allocation table comprises one of a cell allocation (CA) table and a mobile allocation (MA) table.

18. A mobile communication device, comprising:
a radio frequency (RF) chain; and
a control unit configured to:
select an absolute radio frequency channel number (ARFCN) from a first ARFCN set for one or more frequency bands supported by or enabled on the mobile communication device;
determine whether the selected ARFCN is included in at least one allocation table of a first cell of a first PLMN;
in response to determining that the selected ARFCN is included in the at least one allocation table of the first cell of the first PLMN, add the selected ARFCN to a second ARFCN set; and
determine a PLMN identity (PLMN-ID) for each ARFCN in the second ARFCN set.

19. The mobile communication device of claim 18, wherein in response to determining that the selected ARFCN is included in the at least one allocation table of the first cell of the first PLMN, the control unit is further configured to exclude the selected ARFCN from the second ARFCN set.

20. The mobile communication device of claim 18, wherein to determine the PLMN-ID for each ARFCN in the second ARFCN set, the control unit is configured to:
select an ARFCN from the second ARFCN set;
decode information broadcast on a broadcast control channel (BCCH) by a second cell to which the selected ARFCN is allocated; and
determine a PLMN-ID of a second PLMN associated with the second cell to which the selected ARFCN is allocated.

21. The mobile communication device of claim 20, wherein the control unit is further configured to:
determine whether the PLMN-ID of the second PLMN is included in an available PLMN set; and
in response to determining the PLMN-ID of the second PLMN is not included in the available PLMN set, add the PLMN-ID of the second PLMN to the available PLMN set.

22. The mobile communication device of claim 21, wherein in response to determining the PLMN-ID of the second PLMN is included in the available PLMN set, the control unit is configured to exclude the PLMN-ID of the second PLMN from the available PLMN set.

23. The mobile communication device of claim 21, wherein the control unit is further configured to add a PLMN-ID of the first PLMN to the available PLMN set.

24. The mobile communication device of claim 23, wherein the control unit is further configured to provide, on the mobile communication device, an indication of one or more available PLMNs based at least in part on the available PLMN set.

25. The mobile communication device of claim 24, wherein to provide, on the mobile communication device, the indication of the one or more available PLMNs, the control unit is configured to display, on the mobile communication device, one or more available PLMNs corresponding to the PLMN-IDs included in the available PLMN set to a user.

26. The mobile communication device of claim 24, wherein the control unit is further configured to:
receive a selection of a PLMN of the one or more available PLMNs; and
perform a PLMN selection based on the selected PLMN to register the mobile communication device on the selected PLMN.

27. The mobile communication device of claim 18, wherein the control unit is further configured to provide, on the mobile communication device, an indication of one or more available PLMNs based at least in part on the PLMN-ID for each of the ARFCNs in the second ARFCN set.

28. The mobile communication device of claim 18, wherein the control unit is further configured to generate the first ARFCN set for the one or more frequency bands supported by or enabled on the mobile communication device.

29. The mobile communication device of claim 28, wherein to generate the first ARFCN set, the control unit is configured to:
perform a power scan across a plurality of ARFCNs included in the one or more frequency bands supported by or enabled on the mobile communication device;
sort a plurality of ARFCNs included in a result of the power scan based at least in part on a strength of a signal measured at each ARFCN; and
generate the first ARFCN set from the sorted plurality of ARFCNs.

30. The mobile communication device of claim 29, wherein to perform the power scan, the control unit is configured to:
select an ARFCN from the one or more frequency bands supported by or enabled on the mobile communication device; and
measure a strength of a signal at the selected ARFCN.
